(19) United States
(12) Patent Application Publication
(10) Pub. No.: US 2016/0035128 A1
(43) Pub. Date: Feb. 4, 2016

(54) GRAPHICS PROCESSING SYSTEM FOR PERFORMING DEFERRED VERTEX ATTRIBUTE SHADING BASED ON SPLIT VERTEX BITSTREAMS AND RELATED GRAPHICS PROCESSING METHOD

(71) Applicant: MediaTek Singapore Pte. Ltd., Singapore (SG)

(72) Inventors: Xiayang Zhao, San Jose, CA (US); Qun-Feng Liao, San Jose, CA (US); Hsilin Huang, Cupertino, CA (US); Pei-Kuei Tsung, New Taipei City (TW); Sung-Fang Tsai, Hsinchu City (TW)

(21) Appl. No.: 14/689,062

(22) Filed: Apr. 17, 2015

Related U.S. Application Data
(60) Provisional application No. 62/032,632, filed on Aug. 3, 2014.

(51) Int. Cl. G06T 15/80; G06T 15/08; G06T 1/20

(52) U.S. Cl. CPC G06T 15/80; G06T 1/20; G06T 15/08; G06T 2200/04

(57) ABSTRACT

A graphics processing system includes a first storage device, a second storage device, a vertex position shader, a vertex classification module, and a vertex attribute shader. The vertex position shader performs vertex position shading for vertices of primitives in a frame at a binning process. The vertex classification module classifies the vertices of the primitives in the frame into first-type vertices and second-type vertices according to vertex distribution. The vertex attribute shader performs deferred vertex attribute shading for the first-type vertices and the second-type vertices at a rendering process following the binning process, wherein vertex attribute shading results of at least a portion of the first-type vertices classified by the vertex classification module are stored in the second storage device, and vertex attribute shading results of at least a portion of the second-type vertices classified by the vertex classification module are stored in the first storage device.

### CROSS REFERENCE TO RELATED APPLICATIONS

This application claims the benefit of U.S. provisional application No. 62/032,632, filed on Aug. 3, 2014 and incorporated herein by reference.

### BACKGROUND

The present invention relates to graphics processing, and more particularly, to a graphics processing system for performing deferred vertex attribute shading based on split vertex bitstreams and a related graphics processing method.

As known in the art, graphics processing is typically carried out in a pipelined fashion, with multiple pipeline stages operating on the data to generate the final rendering output (e.g., a frame that is displayed). Many graphics processing pipelines now include one or more programmable processing stages, commonly referred to as “shaders”, which execute programs to perform graphics processing operations to generate the desired graphics data. For example, the graphics processing pipeline may include a vertex shader and a pixel (fragment) shader. These shaders are programmable processing stages that may execute shader programs on input data values to generate a desired set of output data values for being further processed by the rest of the graphics pipeline stages. The shaders of the graphics processing pipeline may share programmable processing circuitry, or may be distinct programmable processing units.

For example, the vertex shading operation may include a vertex position shading operation and a vertex attribute shading operation for vertices of primitives in each frame. With regard to a bin-based rendering scheme, there are two choices for shading vertex attributes. One conventional design is to perform the vertex attribute shading at the binning process (i.e., vertex phase (VP) pass) and store the vertex attribute shading results of vertices of all primitives in the frame into a bin memory. Since one vertex attribute shading may be performed for each vertex once, the shading burden may be reduced. However, since the bin memory is needed to store vertex attribute shading results of many vertices, the memory traffic and the memory space requirement is large. In addition, the performance drop may occur in some cases.

The other conventional design is to perform the vertex attribute shading at the rendering process (i.e., pixel phase (PP) pass) after the binning process is done and store the vertex attribute shading results of vertices in an on-chip cache. Since the vertex attribute shading results are stored in the on-chip cache only, the memory traffic and memory space requirement of the bin memory can be reduced. However, since the vertex attribute is shaded on-the-fly when being used, the performance drop may occur due to excessive repeated attribute shading for vertices that may have been shaded before or inefficient SIMD (single input multiple output) execution resulting from insufficient bin vertex count.

Thus, there is a need for an innovative vertex attribute shading design which is capable of avoiding excessive vertex attribute shading results being written to and read from a bin memory without too much loss of the shading performance.

### SUMMARY

One of the objectives of the claimed invention is to provide a graphics processing system for performing deferred vertex attribute shading based on split vertex bitstreams and a related graphics processing method.

According to a first aspect of the present invention, an exemplary graphics processing system is disclosed. The exemplary graphics processing system includes a first storage device, a second storage device, a vertex position shader, a vertex classification module, and a vertex attribute shader. The vertex position shader is arranged to perform vertex position shading for vertices of primitives in a frame at a binning process. The vertex classification module is arranged to classify the vertices of the primitives in the frame into first-type vertices and second-type vertices according to vertex distribution. The vertex attribute shader is arranged to perform deferred vertex attribute shading for the first-type vertices and the second-type vertices at a rendering process following the binning process, wherein vertex attribute shading results of at least a portion of the first-type vertices classified by the vertex classification module are stored in the second storage device, and vertex attribute shading results of at least a portion of the second-type vertices classified by the vertex classification module are stored in the first storage device.

According to a second aspect of the present invention, an exemplary graphics processing method is disclosed. The exemplary graphics processing method includes: performing vertex position shading for vertices of primitives in a frame at a binning process; classifying the vertices of the primitives in the frame into first-type vertices and second-type vertices according to vertex distribution; and performing deferred vertex attribute shading for the first-type vertices and the second-type vertices at a rendering process following the binning process, wherein vertex attribute shading results of at least a portion of the first-type vertices classified by the classifying step are stored in a second storage device but not a first storage device, and vertex attribute shading results of at least a portion of the second-type vertices classified by the classifying step are stored in the first storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a graphics processing system according to an embodiment of the present invention.

FIG. 2 is a diagram illustrating an example of a vertex classification operation performed by a vertex classification module shown in FIG. 1.

FIG. 3 is a diagram illustrating a bin memory according to an embodiment of the present invention.

FIG. 4 is a diagram illustrating a vertex buffer structure according to an embodiment of the present invention.

FIG. 5 is a diagram illustrating a first example of grouping/packing un-shaded vertices into a wave of SIMD execution.

FIG. 6 is a diagram illustrating a second example of grouping/packing un-shaded vertices into a wave of SIMD execution.

FIG. 7 is a diagram illustrating a third example of grouping/packing un-shaded vertices into a wave of SIMD execution.

FIG. 8 is a diagram illustrating a cache hierarchy design according to an embodiment of the present invention.

FIG. 9 is a block diagram illustrating another graphics processing system according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

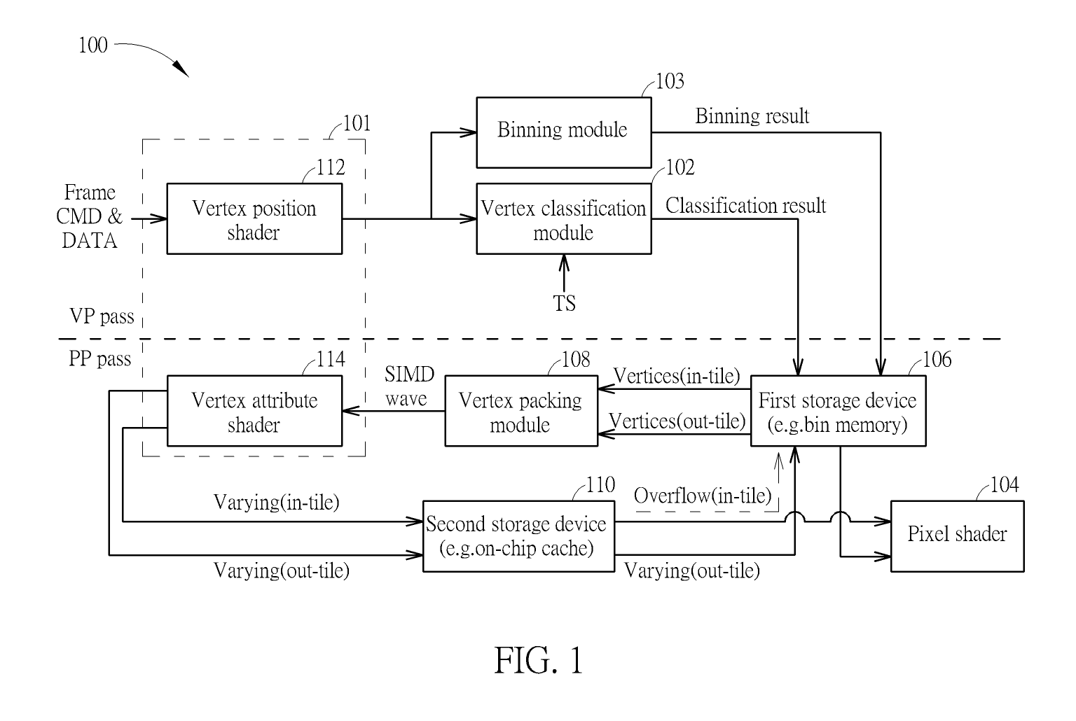

FIG. 1 is a block diagram illustrating a graphics processing system according to an embodiment of the present invention. At least a portion of the graphics processing system 100 may be part of a graphics processing unit (GPU) used in an electronic device, and may include a vertex shader 101, a vertex classification module 102, a binning module 103, a pixel shader 104, a first storage device 106, a vertex packing module 108, and a second storage device 110. The vertex shader 101, vertex classification module 102, binning module, pixel shader 104, and vertex packing module 108 may be implemented using programmable processing circuitry. In this embodiment, the vertex shader 101 may include a vertex position shader 112 and a vertex attribute shader 114. The vertex position shader 112 is arranged to perform vertex position shading (i.e., vertex position computation) ata binning process (i.e., a vertex phase (VP) pass), while the vertex attribute shader 114 is arranged to perform vertex attribute shading (i.e., vertex attribute computation) at a rendering process (i.e., a pixel phase (PP) pass) after the binning process. The pixel shader 104 is arranged to perform pixel (fragment) shading based at least partly on vertex attribute shading results (or called varying data) of vertices of primitives in a frame, where the pixel (fragment) shading is performed at the rendering process (i.e., PP pass). Further details of the graphics processing system 100 are described as below.

The command and data of a frame are fed into the vertex position shader 112 to undergo vertex position shading. As shown in FIG. 1, the positions of vertices of primitives in the frame are computed at the vertex position shader 112 and then supplied to the vertex classification module 102 and the binning module 103. In this embodiment, the pixel shader 104 is arranged to employ a bin-based rendering scheme. Hence, at the VP pass, the binning module 103 divides a screen space (i.e., one frame) into a plurality of bins according to the vertex position information given by the vertex position shader 112. Specifically, concerning each primitive having vertices processed by the preceding vertex position shader 112 and required to be processed by the following pixel shader 104, the binning module 103 checks distribution of the primitive in the screen space to find out bin(s) covered by the primitive, and stores primitive information of the primitive into a table (or a list) in the first storage device 106 (e.g., an off-chip bin memory).

Since the vertex attribute shading is deferred to a post-binning pass (i.e., PP pass), the binning process can be done fast and avoid storing varying data (i.e., vertex attribute shading results) of vertices into the first storage device 106. In addition to the vertex shader and the pixel shader, pre-depth (Pre-Z) processing is a feature supported by many GPUs. The Pre-Z processing stage is placed before a pixel shading stage in the pipeline. For example, if the Pre-Z processing stage decides that a primitive is behind a geometry (i.e., the primitive in a screen space is invisible), the primitive can be discarded such that following processing of the primitive can be omitted to save the system resource. Hence, the graphics processing system 100 may be configured to apply hidden surface removal processing (i.e., Pre-Z operation) per bin/tile before the vertex attribute shading begins at the PP pass.

With regard to the vertex classification module 102, it is arranged to classify vertices of primitives in a frame into first-type vertices (e.g., in-tile vertices or local vertices) and second-type vertices (e.g., out-tile vertices or global vertices) according to vertex distribution indicated by the vertex position information generated from the vertex position shader 112, and then store the classification result (i.e., information associated with in-tile vertices and out-tile vertices) into a table (or a list) in the first storage device 106. In this embodiment, the vertex classification module 102 is arranged to use a tile size TS for dividing screen display space (i.e., one frame) into a plurality of tiles each having at least one bin, where each of the first-type vertices (in-tile vertices) classified by the vertex classification module 102 is used by primitive (s) within a single tile of the tiles only, and each of the second-type vertices (out-tile vertices) classified by the vertex classification module 102 is used by primitive(s) across multiple tiles of the tiles. That is, when a primitive covers more than one tile, its associated vertices are classified as second-type vertices (out-tile vertices). Hence, multiple tiles may share vertex attribute shading results (varying data) of the second-type vertices (out-tile vertices) because the multiple tiles share the same primitive.

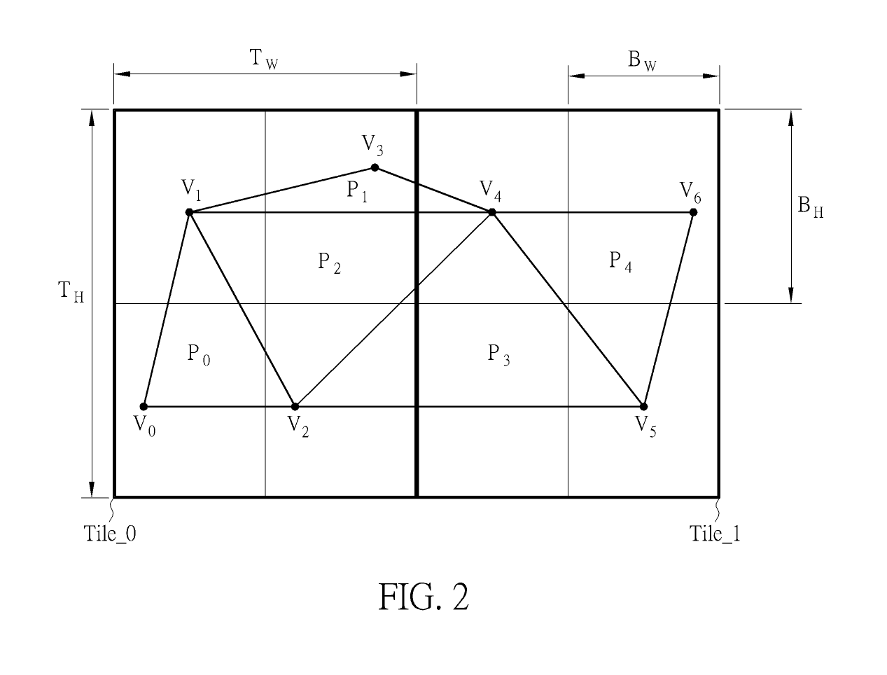

FIG. 2 is a diagram illustrating an example of a vertex classification operation performed by the vertex classification module 102 shown in FIG. 1. In this example, the tile size TS is set by T_{W}×T_{H}, where T_{W} represents a tile width, and T_{H} represents a tile height. Suppose that the tile width T_{W} (e.g., 64) is two times as large as the bin width B_{W} (e.g., 32), and the tile height T_{H} (e.g., 64) is two times as large as the bin height B_{H} (e.g., 32). Hence, one tile with the tile size TS=64×64 is composed of 4 bins each having the bin size set by 32×32. For clarity and simplicity, only two tiles Tile_{—}0 and Tile_{—}1 are illustrated in FIG. 2. As shown in FIG. 2, there are seven vertices V₀-V₆ inside the tiles Tile_{—}0 and Tile_{—}1. Specifically, the primitive P₀ has vertices V₀, V₁, and V₂; the primitive P₁ has vertices V₁, V₃, and V₄; the primitive P₂ has vertices V₁, V₂, and V₄; the primitive P₃ has vertices V₂, V₄, and V₅; and the primitive P₄ has vertices V₄, V₅, and V₆. The primitive P₀ is fully inside the tile Tile_{—}0, and the primitive P₄ is fully inside the tile Tile_{—}1. Each of the primitives P₁, P₂ and P₃ is across multiple tiles Tile_{—}0 and Tile_{—}1. Since each of the primitives P₁, P₂ and P₃ intersects with more than one tile, each of the primitives P₁, P₂ and P₃ is partially inside one tile Tile_{—}0 and is further partially inside the other tile Tile_{—}1.

Concerning the vertex V₀, it is used/referenced by a single primitive P₀ only. Since the primitive P₀ is inside a single tile Tile_{—}0 only, the vertex V₀ is classified as a first-type vertex (in-tile vertex). Concerning the vertex V₁, it is used/referenced by multiple primitives P₀, P₁, and P₂. Since at least one of the primitives P₀, P₁, and P₂ (i.e., each of primitives P₁ and P₂) is across multiple tiles Tile_{—}0 and Tile_{—}1, the vertex V₁ is classified as a second-type vertex (out-tile vertex). Concerning the vertex V₂, it is used/referenced by multiple primitives P₀, P₂, and P₃. Since at least one of the primitives P₀, P₂, and P₃ (i.e., each of primitives P₂ and P₃) is across multiple tiles Tile_{—}0 and Tile_{—}1, the vertex V₂ is classified as a second-type vertex (out-tile vertex). Concerning the vertex V₃, it is used/referenced by a single primitive P₁ only. Since the primitive P₁ is across multiple tiles Tile_{—}0 and Tile_{—}1, the vertex V₃ is classified as a second-type vertex (out-tile vertex). Concerning the vertex V₄, it is used/referenced by multiple primitives P₁, P₂, P₃, and P₄. Since at least one of the primitives P₁, P₂, P₃, and P₄ (i.e., each of primitives P₁, P₂ and P₃) is across multiple tiles Tile_{—}0 and Tile_{—}1, the vertex V₄ is classified as a second-type vertex (out-tile vertex). Concerning the vertex V₅, it is used/referenced by multiple primitives P₃ and P₄. Since at least one of the primitives P₃ and P₄ (i.e., primitive P₃) is across multiple tiles Tile_{—}0 and Tile_{—}1, the vertex V₅ is classified as a second-type vertex (out-tile vertex). Concerning the vertex V₆, it is used/referenced by a single primitive P₄ only. Since the primitive P₄ is inside a single tile Tile_{—}1 only, the vertex V₆ is classified as a first-type vertex (in-tile vertex).

The first-type vertices (called in-tile vertices hereinafter) and the second-type vertices (called out-tile vertices hereinafter) are split into two streams of vertices that will be shaded for attributes after the binning process. The proposed deferred vertex attribute shading design employs a split-stream deferred vertex attribute shading scheme, and treats the in-tile vertices and the out-tile vertices differently in two ways. For example, vertex attribute shading results of at least a portion (i.e., part or all) of the in-tile vertices classified by the vertex classification module 102 are stored in the second storage device (e.g., an on-chip cache) 110 but not the first storage device (e.g., an off-chip bin memory) 106, and vertex attribute shading results of at least a portion (i.e., part of all) of the out-tile vertices are stored in the first storage device 106. Since an out-tile vertex is used/referenced by a primitive intersecting with multiple primitive, the vertex attribute shading result of the out-tile vertex stored in the first storage device 106 is calculated and used by the pixel shader 104 when pixel/fragment shading is applied to at least one bin in one tile, and the vertex attribute shading result of the out-tile vertex can be loaded from the first storage device 106 and can be reused by the pixel shader 104 when pixel/fragment shading is applied to at least one bin in another tile. An in-tile vertex is shaded by vertex attribute shading on-the-fly when being used, and a vertex attribute shading result of the in-tile vertex is not written into the first storage device 106 inmost cases, thus saving the memory traffic of the first storage device 106. It should be noted that out-tile vertices are shaded by the vertex attribute shader 114 with lower priority than in-tile ones when they are not for immediate use for the current tile.

As can be seen from FIG. 2, the tile size TS (TS=T_{W}×T_{H}) defines tile boundaries used for judging whether a primitive interests with a single tile or multiple tiles. In other words, the tile size TS (TS=T_{W}×T_{H}) defines tile boundaries used for classifying a vertex as an in-tile vertex or an out-tile vertex. In one exemplary design, the vertex classification module 102 is arranged to select one tile size TS for each frame, adaptively.

For example, the tile size TS for each frame is adaptively selected based on static determination. That is, the tile size TS for each frame is adaptively selected based on non-frame-adaptive condition(s). The static determination may depend on a screen resolution of an application because the ratio of out-tile vertices to in-tile vertices changes with the screen resolution of the application. Alternatively, the static determination may depend on the number of shader units employed because more shading power employed can afford re-shading and keep less varying data of out-tile vertices going to the first storage device 106.

For another example, the tile size TS for each frame is adaptively selected based on dynamic determination. That is, the tile size TS for each frame is adaptively selected based on frame-adaptive condition(s). The dynamic determination may depend on whether a shader-bound or memory bound status of a frame changes. Alternatively, the dynamic determination may depend on whether an average primitive size of a frame changes.

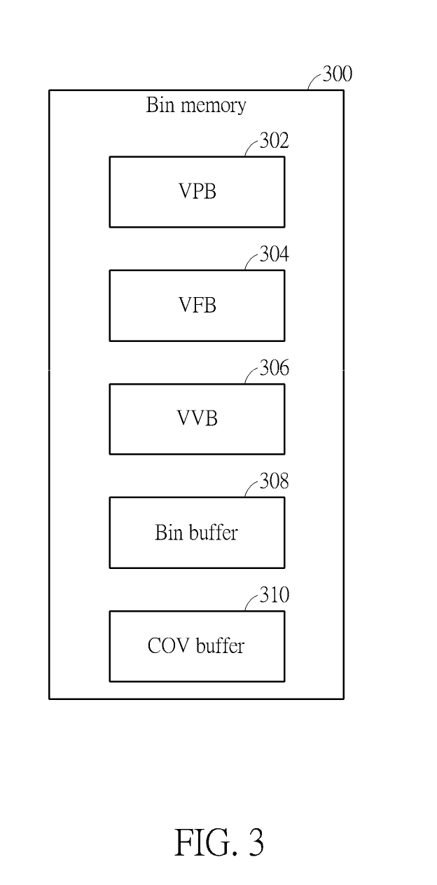

The binning result generated by the binning module 103 and the classification result generated by the vertex classification module 102 are stored into the first storage device 106. In one exemplary design, the first storage device 106 may be implemented using a bin memory 300 shown in FIG. 3. The bin memory 300 may be an off-chip dynamic random access memory (DRAM), and may include a vertex position buffer (VPB) 302, a vertex flag buffer (VFB) 304, a vertex varying buffer (VVB) 306, a bin buffer 308, a circular overflow (COV) buffer, and miscellaneous buffers (not shown). The VPB 302, VFB 304 and VVB 306 are used for storing vertex-related data, including the classification result generated from the vertex classification module 102 and the varying data (i.e., vertex attribute shading results) of out-tile vertices generated from the vertex attribute shader 114. The VVB 306 is used to store the varying data (i.e., vertex attribute shading results) of out-tile vertices generated from the vertex attribute shader 114. Specifically, the vertex attribute shading results of out-tile vertices will be always flushed to the VVB 306 at the first priority. The VPB 302 is used to store a vertex identifier (VID), vertex position data (x, y, z, w) and a pointer for each vertex. When the vertex is an in-tile vertex, the pointer is set by a NULL value. When the vertex is an out-tile vertex, the pointer is set by an address value in the VVB 306 to indicate the location of a corresponding vertex attribute shading result stored in the VVB 306. That is, the pointer recorded in the VPB 302 will point to the corresponding vertex attribute shading result in the VVB 306.

The VFB 304 is used to store flags of each vertex. For example, the flags of each vertex may include is_shaded, is_in_tile, etc. The flag is_shaded is indicative of a shading status of the vertex. For example, when the flag is_shaded of a vertex is set by “1” (i.e., is_shaded=1 (true)), it means the vertex attribute shading has been done to the vertex; and when the flag is_shaded of the vertex is set by “0” (i.e., is_shaded=0 (false)), it means the vertex attribute shading has not been done to the vertex. Initially, the flag is_shaded of each vertex is set by “0”. The flag is_in_tile is indicative of a vertex type of the vertex. For example, when a vertex is classified as a first-type vertex (in-tile vertex), is_in_tile=1 (true); and when a vertex is classified as a second-type vertex (out-tile vertex), is_in_tile=0 (false).

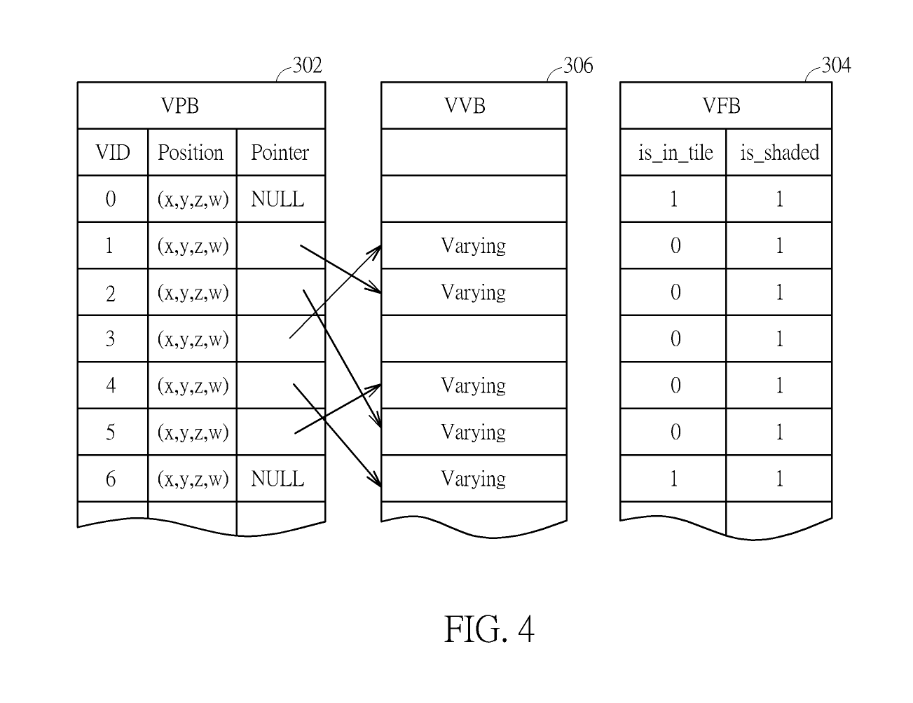

FIG. 4 is a diagram illustrating a vertex buffer structure according to an embodiment of the present invention. Take the primitives P₀-P₄ and associated vertices V₀-V₆ shown in FIG. 2 for example. The vertices V₀-V₆ have VIDs 0-6, respectively. Hence, the VPB 302 stores VIDs and position data of the vertices V₀-V₆. As mentioned above, each of vertices V₀ and V₆ is an in-tile vertex, while each of the vertices V₁-V₅ is an out-tile vertex. Hence, flags is_in_tile of the vertices V₀ and V₆ are set by “1”, and flags is_in_tile of the vertices V₁-V₅ are set by “0”. After the vertices V₀-V₆ are processed by the vertex attribute shader 114, the flags is_shaded of the vertices V₀-V₆ are set by “1”. Since each of vertices V₀ and V₆ is an in-tile vertex, the VPB 302 may store NULL pointers for vertices V₀ and V₆. Since each of the vertices V₁-V₅ is an out-tile vertex, vertex attribute shading results of vertices V₁-V₅ may be stored into the VVB 306. Hence, the VPB 302 may store pointers pointing to memory addresses of stored vertex attribute shading results in the VVB 306.

Please refer to FIG. 3 again. The bin buffer 308 is used to store the binning result generated from the binning module 103. For each bin, the bin buffer 308 may use list# and vertex pointers pointing to the VPB 304 for recording information of each primitive that intersects with the bin. As the present invention focuses on the deferred vertex attribute shading operation, further details of the bin buffer 308 used for storing the binning result (i.e., primitive and vertex information associated with each bin) is omitted here for brevity.

With regard to the COV buffer 310 shown in FIG. 3, it is a fixed-size buffer allocated in the bin memory 300, and is used to buffer varying data (i.e., vertex attribute shading results) of in-tile vertices generated from the vertex attribute shader 114 when an overflow condition of the second storage device 110 is met. When the COV buffer 310 is not full yet, a free space is allocated in the COV buffer 310 for buffering the overflowed varying data. In addition, a vertex pointer in VPB 302 is set to point to this allocated space in COV buffer 310. It should be noted that the COV buffer 310 will circularly reuse its free space. When the COV buffer 310 is full, the COV buffer 310 will stall until any free space becomes available due to a stored vertex attribute shading result of an in-tile vertex data being referenced by the pixel shader 104. In this embodiment, the second storage device 110 may be implemented using an on-chip cache. The vertex attribute shading results of in-tile vertices are not kept in the VVB 306, but may be kept in the second storage device 110 (if the overflow condition is not met) or the COV buffer 310 (if the overflow condition is met). In other words, the priority of writing vertex attribute shading results of in-tile vertices into the on-chip cache is higher than the priority of writing vertex attribute shading results of in-tile vertices into a fixed-size buffer allocated in an off-chip bin memory. Though the COV buffer 310 is allocated in the off-chip bin memory, the COV buffer 310 is implemented using a fixed-size buffer, which is beneficial for bin memory size control.

As mentioned above, the vertex attribute shader 114 is arranged to perform deferred vertex attribute shading at the PP pass. In this embodiment, the vertex attribute shader 114 may have a plurality of processing elements to support SIMD (single instruction multiple data) execution. For example, a fixed number of inputs of the same processing job (for example, vertices in the same shader kernel/shader type) are collected together into a wave before being sent to the vertex attribute shader 114 using SIMD architecture such as SIMD-64 architecture or SIMD-32 architecture. When the SIMD-64 architecture is employed by the vertex attribute shader 114, the vertex attribute shader 114 can perform SIMD execution of a wave of 64 vertices in the same shader kernel/shader type. When the SIMD-32 architecture is employed by the vertex attribute shader 114, the vertex attribute shader 114 can perform SIMD execution of a wave of 32 vertices in the same shader kernel/shader type. The vertex packing module 108 is arranged to group/pack un-shaded in-tile vertices and un-shaded out-tile vertices of the same shader kernel/shader type in waves of SIMD execution for the deferred vertex attribute shading at the vertex attribute shader 114.

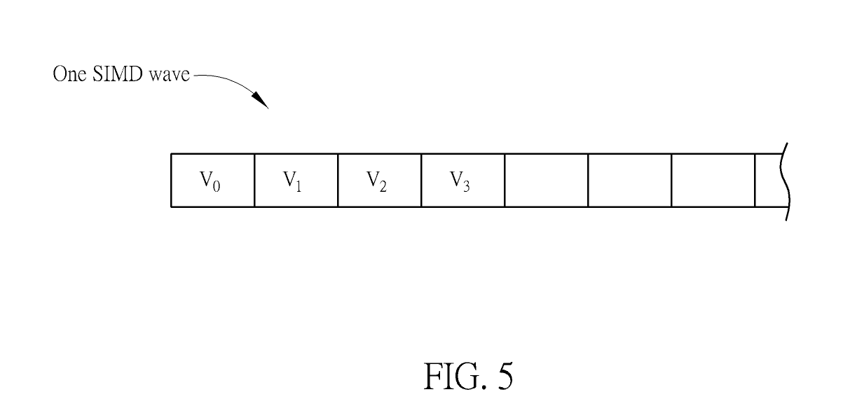

The present invention proposes several manners to group/pack un-shaded first-type vertices (in-tile vertices) and un-shaded second-type vertices (out-tile vertices) of the same shader kernel/shader type. In accordance with a first grouping/packing manner, the vertex packing module 108 groups at least one un-shaded first-type vertex and at least one un-shaded second-type vertex within a same tile into a wave of SIMD execution. FIG. 5 is a diagram illustrating a first example of grouping/packing un-shaded vertices into a wave of SIMD execution. Take vertices V₀-V₆ shown in FIG. 2 for example. Suppose that vertices V₀-V₆ of the same shader kernel/shader type are not processed by vertex attribute shading yet. For the tile Tile_{—}0, the vertex packing module 108 groups the un-shaded in-tile vertex V₀ and the un-shaded out-tile vertices V1-V3 into a wave of SIMD execution. Hence, the vertex attribute shader 114 may shade at least one in-tile vertex and at least one out-tile vertex together, where a vertex attribute shading result of each in-tile vertex is part of a first output bitstream going to an on-chip cache or a COV buffer allocated in an off-chip bin memory, and a vertex attribute shading result of each out-tile vertex is part of a second output bitstream going to a VVB allocated in the off-chip bin memory.

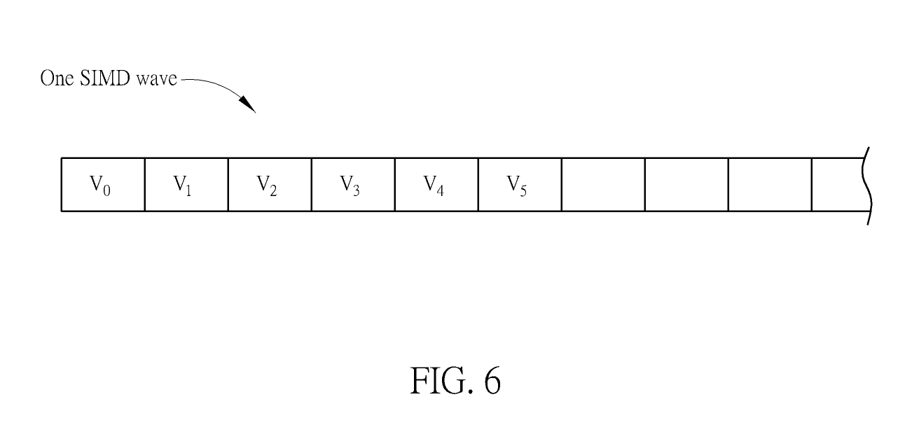

To improve un-shaded out-tile vertex grouping, the first grouping/packing manner is modified to extend the un-shaded out-tile vertex grouping from a current tile to at least one neighboring tile (e.g., four neighboring tiles). Hence, in accordance with a second grouping/packing manner, the vertex packing module 108 groups at least one un-shaded in-tile vertex within a current tile and un-shaded out-tile vertices within the current tile and at least one neighboring tile into a wave of SIMD execution. FIG. 6 is a diagram illustrating a second example of grouping/packing un-shaded vertices into a wave of SIMD execution. Take vertices V₀-V₆ shown in FIG. 2 for example. Suppose that vertices V₀-V₆ of the same shader kernel/shader type are not processed by vertex attribute shading yet. For the tile Tile_{—}0, the vertex packing module 108 groups the un-shaded in-tile vertex V₀ within the tile Tile_{—}0, the un-shaded out-tile vertices V1-V3 within the tile Tile_{—}0, and the un-shaded out-tile vertices V4-V5 within the neighboring tile Tile_{—}1 into a wave of SIMD execution, where a vertex attribute shading result of each in-tile vertex is part of a first output bitstream going to an on-chip cache or a COV buffer allocated in an off-chip bin memory, and a vertex attribute shading result of each out-tile vertex is part of a second output bitstream going to a VVB allocated in the off-chip bin memory

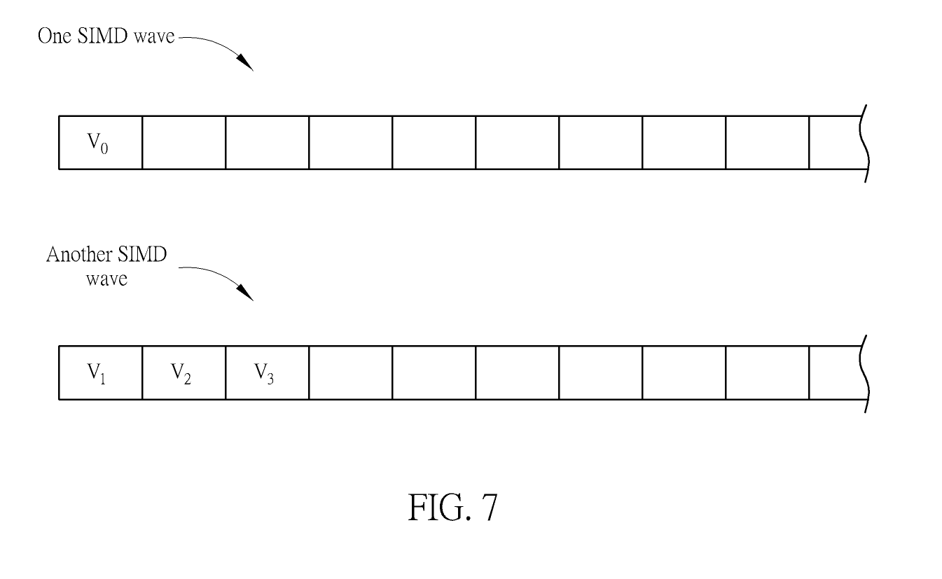

In accordance with a third grouping/packing manner, the vertex packing module 108 groups un-shaded in-tile vertices located only within a same tile into a wave of SIMD execution, and groups un-shaded out-tile vertices located only within a same tile into a wave of SIMD execution. FIG. 7 is a diagram illustrating a third example of grouping/packing un-shaded vertices into a wave of SIMD execution. Take vertices V₀-V₆ shown in FIG. 2 for example. Suppose that vertices V₀-V₆ of the same shader kernel/shader type are not processed by vertex attribute shading yet. For the tile Tile_{—}0, the vertex packing module 108 groups the un-shaded in-tile vertex V₀ into a wave of SIMD execution, and groups the un-shaded out-tile vertices V1-V3 into another wave of SIMD execution, where a vertex attribute shading result of each in-tile vertex is part of a first output bitstream going to an on-chip cache or a COV buffer allocated in an off-chip bin memory, and a vertex attribute shading result of each out-tile vertex is part of a second output bitstream going to a VVB allocated in the off-chip bin memory.

The vertex attribute shader 114 applies different storage strategies to vertex attribute shading results (i.e., varying data) of the in-tile vertices and vertex attribute shading results (i.e., varying data) of the out-tile vertices. Specifically, the vertex attribute shading results (i.e., varying data) of at least a portion (i.e., part or all) of the in-tile vertices processed by the vertex attribute shader 114 are stored in the second storage device (e.g., on-chip cache) 110 only, while the vertex attribute shading results (i.e., varying data) of all out-tile vertices processed by the vertex attribute shader 114 will be eventually written into the first storage device (e.g., off-chip bin memory) 106.

Consider a case where one tile is composed of multiple bins. When a vertex attribute shading result of an in-tile vertex inside one bin of a tile is held in an on-chip cache and the in-tile vertex is used by a primitive inside the tile, the vertex attribute shading result of the in-tile vertex can be reused when another bin of the tile is processed by the pixel shader 104. In other words, caching vertex attribute shading results of in-tile vertices can enable in-tile reuse. However, when an overflow condition of the second storage device 110 is met, meaning that the second storage device 110 is already full or almost full, vertex attribute shading results (i.e., varying data) of a portion of the in-tile vertices processed by the vertex attribute shader 114 may be overflowed to the first storage device 106 such as the COV buffer 310 shown in FIG. 3. Alternatively, when an overflow condition of the second storage device 110 is met, meaning that the second storage device 110 is already full or almost full, vertex attribute shading results (i.e., varying data) of a portion of the in-tile vertices processed by the vertex attribute shader 114 may not be held in the second storage device 110 such that the portion of the in-tile vertices will be re-shaded by the vertex attribute shader 114 when needed.

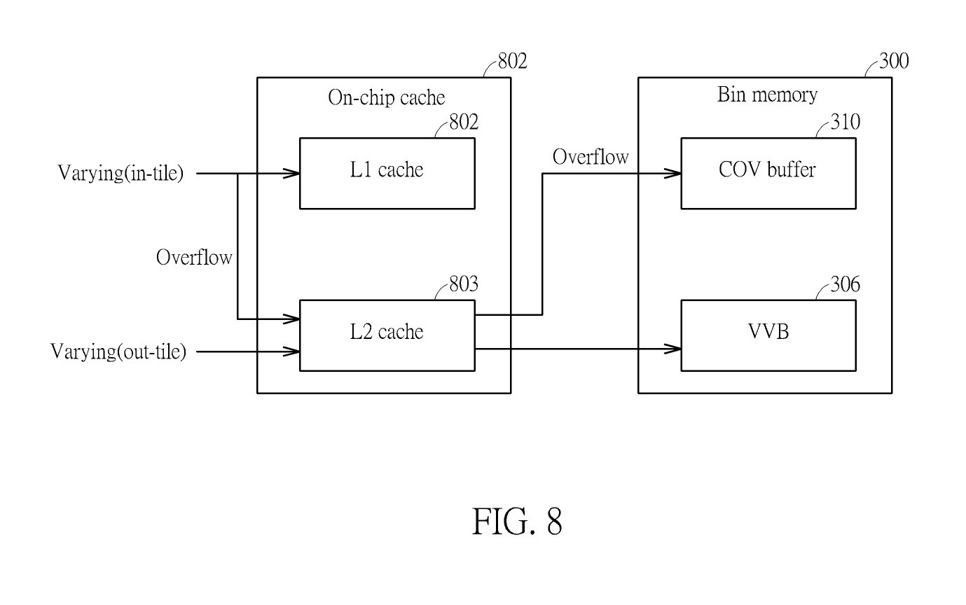

In this embodiment, the vertex attribute shading results of at least a portion of the in-tile vertices and the vertex attribute shading results of at least a portion of the out-tile vertices are held in the on-chip cache, and the vertex attribute shading results of at least a portion of the out-tile vertices are further copied to the bin memory. FIG. 8 is a diagram illustrating a cache hierarchy design according to an embodiment of the present invention. The second storage device 110 may be implemented using the on-chip cache 800 shown in FIG. 8, and the first storage device 106 may be implemented using the bin memory 300 shown in FIG. 3. The on-chip cache 800 has a first-level cache (L1 cache) 802 and a second-level cache (L2 cache) 803. Within the on-chip cache 800, the vertex attribute shading results of at least a portion of the in-tile vertices are cached in the L1 cache 802 only, and the vertex attribute shading results of at least a portion of the out-tile vertices are cached in the L2 cache 803 only. However, when an overflow condition of the on-chip cache 800 is met (more particularly, an overflow condition of the L1 cache 802 is met), vertex attribute shading results of a portion of the in-tile vertices are cached in the L2 cache 803, and then copied/overflowed to the COV buffer 310 in the bin memory 300. In other words, within the on-chip cache 800, vertex attribute shading results of a portion of the in-tile vertices are cached in the L1 cache 802, and vertex attribute shading results of another portion of the in-tile vertices to be overflowed to the COV buffer 310 and vertex attribute shading results of at least a portion of the out-tile vertices are cached in the L2 cache 803.

When a vertex attribute shading result of a specific vertex (e.g., a non-overflowed in-tile vertex, an out-tile vertex, or an overflowed in-tile vertex) is requested by the pixel shader 104 and a cache hit occurs, the requested vertex attribute shading result of the specific vertex can be read from the on-chip cache 802 without needing any memory traffic of the bin memory 300. However, when a vertex attribute shading result of a specific vertex (e.g., an out-tile vertex or an overflowed in-tile vertex) is requested by the pixel shader 104 and a cache miss occurs, the requested vertex attribute shading result of the specific vertex is not available in the on-chip cache 802, and memory traffic of the bin memory 300 is needed to obtain the requested vertex attribute shading result of the specific vertex.

With regard to the system configuration shown in FIG. 1, vertex attribute shading results of out-tile vertices are written into the first storage device (e.g., off-chip memory) 106 through the second storage device (e.g., on-chip cache) 110. However, this is for illustrative purposes only, and is not meant to be a limitation of the present invention. Alternatively, vertex attribute shading results of out-tile vertices may be written into the first storage device (e.g., off-chip memory) 106 without through the second storage device (e.g., on-chip cache) 110. This also falls within the scope of the present invention.

In general, each of the first storage device 106 and the second storage device 110 has a limited storage capacity. To buffer vertex attribute shading results of more first-type vertices (in-tile vertices) and second-type vertices (out-tile vertices), a data compression and decompression technique may be employed by a graphics processing system. Hence, vertex attribute shading results of first-type vertices (in-tile vertices) and second-type vertices (out-tile vertices) can be further compressed upon storing and de-compressed upon use.

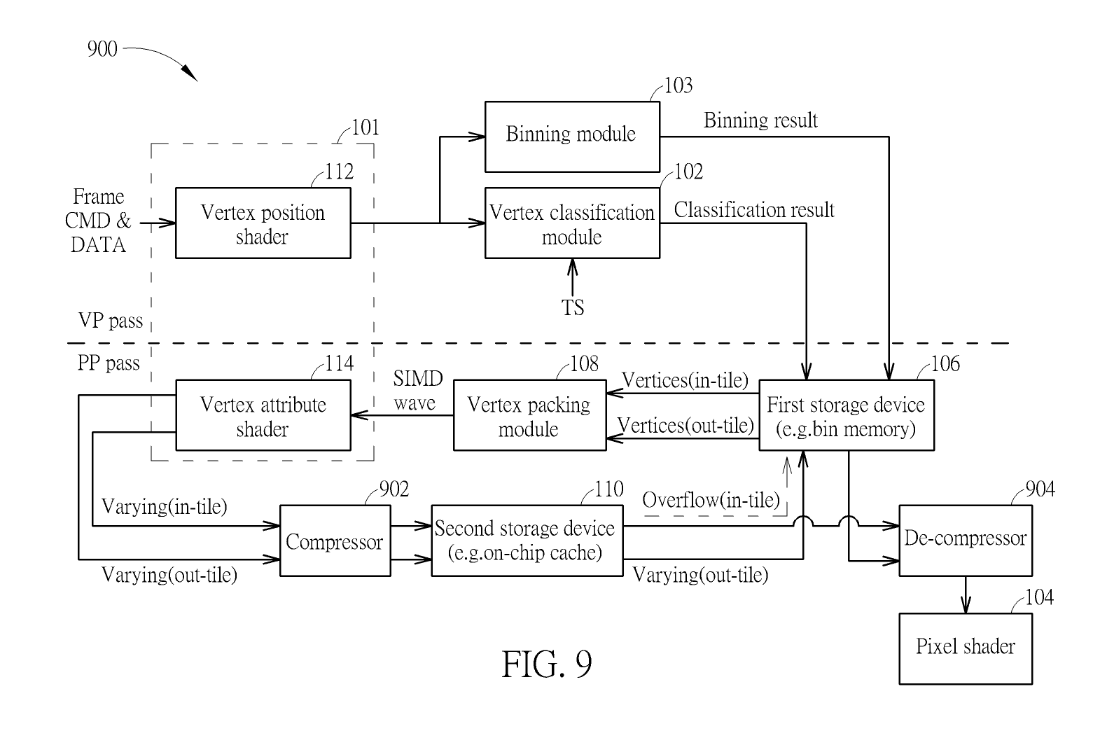

FIG. 9 is a block diagram illustrating another graphics processing system according to an embodiment of the present invention. At least a portion of the graphics processing system 900 may be part of a GPU used in an electronic device. The major difference between the graphics processing systems 100 and 900 is that the graphics processing system 900 further includes a compressor 902 and a de-compressor 904. The compressor 902 may employ a lossless compression algorithm or a lossy compression algorithm, depending upon the actual design consideration. The vertex attribute shading results of first-type vertices (in-tile vertices) and second-type vertices (out-tile vertices) are stored into the second storage device 110 through the compressor 902. In this way, the second storage device 110 shown in FIG. 9 is used to store compressed vertex attribute shading results of first-type vertices (in-tile vertices) and second-type vertices (out-tile vertices), and the first storage device 106 shown in FIG. 9 is used to store compressed vertex attribute shading results of second-type vertices (out-tile vertices), and is further used to store compressed vertex attribute shading results of first-type vertices if the overflow condition of the second storage device 110 is met.

The de-compressor 904 is arranged to use a decompression algorithm matching the compression algorithm used by the compressor 902. The compressed vertex attribute shading results of the first-type vertices and the second-type vertices are transmitted to the pixel shader 104 through the de-compressor 904. Hence, the de-compressor 904 receives a compressed vertex attribute shading result of a requested vertex from one of the first storage device 106 and the second storage device 110, and outputs a de-compressed vertex attribute shading result of the requested vertex to the pixel shader 104 for pixel/fragment shading.

It is noted that, in an alternative design, the compressor 902 may be placed after the second storage device 110. By this implementation, the vertex attribute shading results of first-type vertices (in-tile vertices) and second-type vertices (out-tile vertices) are stored into the second storage device 110 first, and the compressor 902 employs the compression on the vertex attribute shading results thereafter. Thus, the compressor 902 reads vertex attribute shading results of first-type vertices (in-tile vertices) from the second storage device 110 and outputs the compressed vertex attribute shading results of first-type vertices (in-tile vertices) to the de-compressor 904, and reads vertex attribute shading results of second-type vertices (out-tile vertices) and outputs the compressed vertex attribute shading results of second-type vertices (out-tile vertices) to the first storage device 106.

In the example shown in FIG. 2, the tile size TS employed by the vertex classification module 102 is larger than the bin size employed by the binning module 103. When the second storage device 110 is implemented using an on-chip cache, the on-chip cache has a limited storage capacity for caching vertex attribute shading results of first-type vertices (in-tile vertices). When the number of first-type vertices (in-tile vertices) is larger than a predetermined threshold under a current value of the tile size TS, meaning that there are too many first-type vertices (in-tile vertices), the vertex classification module 102 may change the tile size TS from the current value to a smaller value. For example, the tile size TS employed by the vertex classification module 102 may be the same as the bin size employed by the binning module 103.

As mentioned above, the vertex classification is performed by the vertex classification module 102 at the VP pass, and the classification result is referenced by the vertex attribute shader 114 at the PP pass. In one exemplary design, the vertex attribute shader 114 may be further arranged to tune the performance adaptively at the PP phase by re-classifying first-type vertices (in-tile vertices) originally classified by the vertex classification module 102 as second-type vertices (out-tile vertices) and/or re-classifying second-type vertices (out-tile vertices) originally classified by the vertex classification module 102 as first-type vertices (in-tile vertices).

The vertex attribute shader 114 may check a first predetermined criterion. When some primitives are not shared by many tiles and the shader kernel/shader type is short, the first predetermined criterion is met. In a case where the first predetermined criterion is met, the vertex classification module 102 may optionally re-classify some second-type vertices (out-tile vertices) as first-type vertices (in-tile vertices) at the rendering process (i.e., PP pass) to avoid sending many vertex attribute shading results to the first storage device 106. As long as a flag is shaded of a vertex in the VFB 304 is not set by “1” during the vertex attribute shading of one tile, the vertex attribute shading of another tile will not see the vertex as “shaded” and will shade the vertex again. Hence, this re-classification feature is easier to implement.

In addition, the vertex attribute shader 114 may further check a second predetermined criterion. When there are too many first-type vertices (in-tile vertices) in one tile, the shader kernel/shader type is long, and the first-type vertices (in-tile vertices) are used/referenced by primitives across multiple bins in the tile, the second predetermined criterion is met. Hence, in a case where the second predetermined criterion is met, the vertex classification module 102 may optionally re-classify those first-type vertices (in-tile vertices) in the tile as second-type vertices (out-tile vertices) at the rendering process (i.e., PP pass), thereby enabling reuse of vertex attribute shading results of vertices when the pixel shader 104 processes different bins in the tile.

As mentioned above, vertex attribute shading results of first-type vertices (in-tile vertices) are held in the second storage device 110 at the first priority. When an overflow condition of the second storage device 110 is met, one option is to re-shade certain first-type vertices (in-tile vertices). However, when re-shading for first-type vertices (in-tile vertices) still costs a lot of shading power, the vertex attribute shader 114 may either re-classify the first-type vertices (in-tile vertices) as second-type vertices (out-tile vertices) or may overflow vertex attribute shading results of first-type vertices (in-tile vertices) to an off-chip COV buffer to maximize in-tile reuse. Though such a design comes with a price of memory traffic, it will be limited to certain tiles only.

Alternatively, in-tile vertices and out-tile vertices can be classified as all in-tile vertices or all out-tile vertices under certain scenarios. For example, when the application is severely bound by memory traffic, all of the second-type vertices (out-tile vertices) can be treated as first-type vertices (in-tile vertices) at the rendering process (i.e., PP pass). For another example, when the application consists of big triangles or it is required to have all vertex attribute shading results stored into the bin memory, all of the first-type vertices (in-tile vertices) can be treated as second-type vertices (out-tile vertices) at the rendering process (i.e., PP pass).

In summary, the proposed graphics processing system performs deferred vertex attribute shading operation based on split vertex streams, where vertex attribute shading results (i.e., varying data) of in-tile vertices are held in an on-chip cache most of time, thereby saving the memory traffic of an off-chip bin memory. In addition, when compression on attribute shading results (i.e., varying data) of out-tile vertices is implemented, more saving on the memory traffic of the off-chip bin memory can be achieved. Though storing vertex attribute shading results (i.e., varying data) of in-tile vertices in the on-chip cache may consume a small part of the shading power due to re-shading of in-tile vertices, the performance gain due to saving on the memory traffic would surpass the shading loss.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A graphics processing system comprising:
a first storage device;
a second storage device;
a vertex position shader, arranged to perform vertex position shading for vertices of primitives in a frame at a binning process;
a vertex classification module, arranged to classify the vertices of the primitives in the frame into first-type vertices and second-type vertices according to vertex distribution; and
a vertex attribute shader, arranged to perform deferred vertex attribute shading for the first-type vertices and the second-type vertices at a rendering process following the binning process, wherein vertex attribute shading results of at least a portion of the first-type vertices classified by the vertex classification module are stored in the second storage device, and vertex attribute shading results of at least a portion of the second-type vertices classified by the vertex classification module are stored in the first storage device.

2. The graphics processing system of claim 1, wherein the first storage device is a bin memory, and the second storage device is an on-chip cache.

3. The graphics processing system of claim 2, wherein the vertex attribute shading results of at least a portion of the first-type vertices and the vertex attribute shading results of at least a portion of the second-type vertices are cached in the on-chip cache, and the vertex attribute shading results of at least a portion of the second-type vertices are further copied to the bin memory.

4. The graphics processing system of claim 3, wherein the on-chip cache has a first-level cache and a second-level cache; within the on-chip cache, the vertex attribute shading results of at least a portion of the first-type vertices are cached in the first-level cache only, and the vertex attribute shading results of at least a portion of the second-type vertices are cached in the second-level cache only.

5. The graphics processing system of claim 3, wherein the on-chip cache has a first-level cache and a second-level cache; when an overflow condition of the first-level cache is met, within the on-chip cache, vertex attribute shading results of a portion of the first-type vertices are cached in the first-level cache only, and vertex attribute shading results of another portion of the first-type vertices and the vertex attribute shading results of at least a portion of the second-type vertices are cached in the second-level cache only.

6. The graphics processing system of claim 1, wherein at the rendering process, the vertex attribute shader is further arranged to check a predetermined criterion and re-classify at least one of the first-type vertices as at least one second-type vertex when the predetermined criterion is met.

7. The graphics processing system of claim 1, wherein at the rendering process, the vertex attribute shader is further arranged to check a predetermined criterion and re-classify at least one of the second-type vertices as at least one first-type vertex when the predetermined criterion is met.

8. The graphics processing system of claim 1, wherein the vertex classification module is arranged to use a tile size for dividing the frame into a plurality of tiles each having at least one bin; each of the first-type vertices classified by the vertex classification module is used by primitive (s) within a single tile of the tiles only; and each of the second-type vertices classified by the vertex classification module is used by primitive (s) across multiple tiles of the tiles.

9. The graphics processing system of claim 8, wherein the vertex classification module is arranged to select a tile size for each frame, adaptively.

10. The graphics processing system of claim 9, wherein the tile size for each frame is adaptively selected based on static determination.

11. The graphics processing system of claim 9, wherein the tile size for each frame is adaptively selected based on dynamic determination.

12. The graphics processing system of claim 8, wherein each of the tiles has a plurality of bins.

13. The graphics processing system of claim 8, further comprising:
a vertex packing module, arranged to group un-shaded first-type vertices and second-type vertices of a same shader kernel in waves of Single Instruction Multiple Data (SIMD) execution for the deferred vertex attribute shading at the vertex attribute shader.

14. The graphics processing system of claim 13, wherein the vertex packing module groups at least one un-shaded first-type vertex and at least one un-shaded second-type vertex within a same tile into a wave of SIMD execution.

15. The graphics processing system of claim 13, wherein the vertex packing module groups at least one un-shaded first-type vertex within a current tile and un-shaded second-type vertices within the current tile and at least one neighboring tile into a wave of SIMD execution.

16. The graphics processing system of claim 13, wherein the vertex packing module groups un-shaded second-type vertices only within a same tile into a wave of SIMD execution.

17. The graphics processing system of claim 13, wherein the vertex packing module groups un-shaded first-type vertices only within a same tile into a wave of SIMD execution.

18. The graphics processing system of claim 1, wherein the first storage device has an overflow buffer allocated therein; and when an overflow condition of the second storage device is met, a vertex attribute shading result of at least one first-type vertex is overflowed to the overflow buffer.

19. The graphics processing system of claim 1, wherein when an overflow condition of the second storage device is met, a vertex attribute shading result of at least one first-type vertex is not stored into the second storage device, and the vertex attribute shader is arranged to re-shade the at least one first-type vertex.

20. The graphics processing system of claim 1, further comprising:
a compressor, arranged to perform data compression;
wherein the vertex attribute shading results of at least a portion of the first-type vertices are stored into the second storage device through the compressor.

21. The graphics processing system of claim 1, further comprising:
a compressor, arranged to perform data compression;
wherein the vertex attribute shading results of at least a portion of the second-type vertices are stored into the first storage device through the compressor.

22. The graphics processing system of claim 1, further comprising:
a compressor, arranged to compress the vertex attribute shading results of the first-type vertices or the second-type vertices stored in the second storage device.

23. A graphics processing method comprising:
performing vertex position shading for vertices of primitives in a frame at a binning process;
classifying the vertices of the primitives in the frame into first-type vertices and second-type vertices according to vertex distribution; and
performing deferred vertex attribute shading for the first-type vertices and the second-type vertices at a rendering process following the binning process, wherein vertex attribute shading results of at least a portion of the first-type vertices classified by the classifying step are stored in a second storage device but not a first storage device, and vertex attribute shading results of at least a portion of the second-type vertices classified by the classifying step are stored in the first storage device.
